(19) United States
(12) Patent Application Publication
(10) Pub. No.: US 2005/0220317 A1
(43) Pub. Date: Oct. 6, 2005

(54) Ergonomic earphone

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/814,124

(22) Filed: Apr. 1, 2004

(51) Int. Cl. H04R 25/00

(52) U.S. Cl. 381/371; 381/372; 381/373; 381/374

(57) ABSTRACT

An ergonomic earphone is adjustable and adaptable to anyone. The size of the ergonomic earphone can be adjusted according to different ear holes. The ergonomic earphone has an earphone body with a side portion, a silica cover covering on the side portion of the earphone body, and a control device received in the earphone body. The control device has a channel with material therein, a first control device and a second device. The control device communicates with an inside of the silica cover. The first control device is used to transmit the material from the channel to the silica cover for expanding the silica cover 4. The second control device is used to guide the material from the silica cover back to the channel.

### BACKGROUND OF THE INVENTION

(1) Field of the Invention

The present invention relates to an ergonomic earphone, and especially to an adjustable earphone that can adjust the size of the earphone for adapting to anyone.

(2) Description of the Related

In general, the earphone is used more and more frequently on a person. For example, the earphone is used with cell phones and MP3 personal disks. However, the size of the earphone is fixed and the size of the ear hole of everyone is not the same. In other words, the prior art of the earphone is not adjustable and cannot be adapted to anyone. If the size of the earphone is larger than the ear hole of the ear, the user will feel pain and discomfort in the ear. If the size of the earphone is smaller than the ear hole of the ear, the earphone will not be tightly placed in the ear hole of the ear.

Referring to FIG. 1, the prior art provides an first earphone 1 which comprises an earphone body 11 having a hollow side portion 111, a circular plastic cover 12 covering the side portion 111 and a loudspeaker 13 disposed in the side portion 111.

Referring to FIG. 2, the prior art provides an second earphone 2 which comprises an earphone body 21 having a hollow side portion 211, a flexible silica cover 22 covering the side portion 211 and a loudspeaker 23 disposed in the side portion 211.

However, the size of the first and the second earphone 1,2 are fixed and not adjustable. So the prior art of the first and second earphones 1, 2 are not adaptable to anyone.

### SUMMARY OF THE INVENTION

The primary object of the present invention is to provide an ergonomic earphone. The ergonomic earphone has a control device for adjusting the size of the earphone to adapt to anyone for providing comfort.

In order to achieve the above objects, the present invention provides an ergonomic earphone comprising an earphone body, a silica cover and a control device.

The earphone body has a side portion. The silica cover covers the side portion of the earphone body.

The control device communicates with an inside of the silica cover, disposed in the earphone body, and having a channel with material formed therein, a first control device with a part received in the channel for controlling material flow into the inside of the silica cover from the channel, and a second control device with a part received in the channel for controlling material leaving the channel back to the inside of the silica cover.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The various objects and advantages of the present invention will be more readily understood from the following detailed description when read in conjunction with the appended drawing, in which:

FIG. 1 is a side cross-sectional view of the first earphone of the prior art;

FIG. 2 is a side cross-sectional view of the second earphone of the prior art;

FIG. 3 is a perspective view of the rear side according to the first embodiment of the present invention;

FIG. 4 is a side cross-sectional view according to the first embodiment of the present invention;

FIG. 5 is a side cross-sectional view of the control device according to the FIG. 4 of the first embodiment of the present invention;

FIG. 6 is a rear cross-sectional view of the control device according to the first embodiment of the present invention; and

FIG. 7 is a rear cross-sectional view of the control device according to the second embodiment of the present invention.

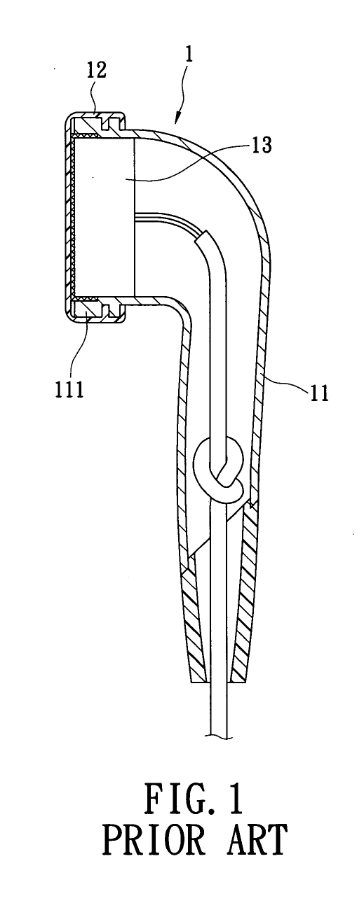

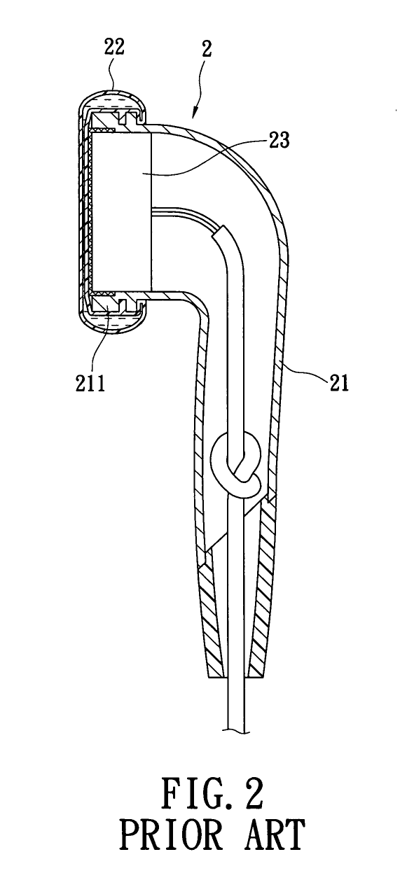

### DETAILED DESCRIPTION OF THE PREFERRED EMBODIMENT

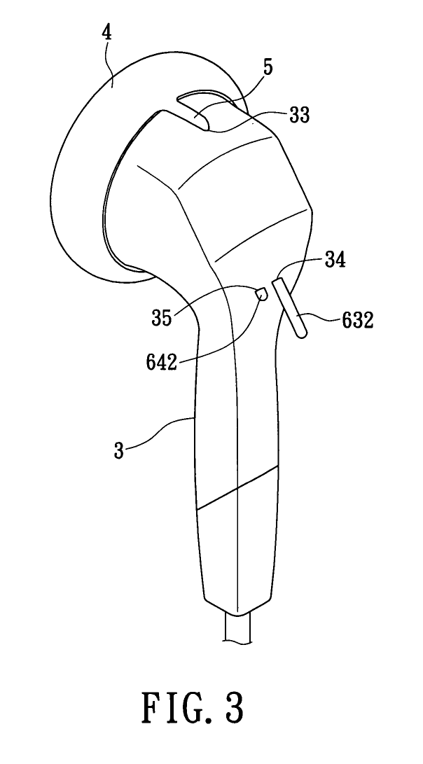

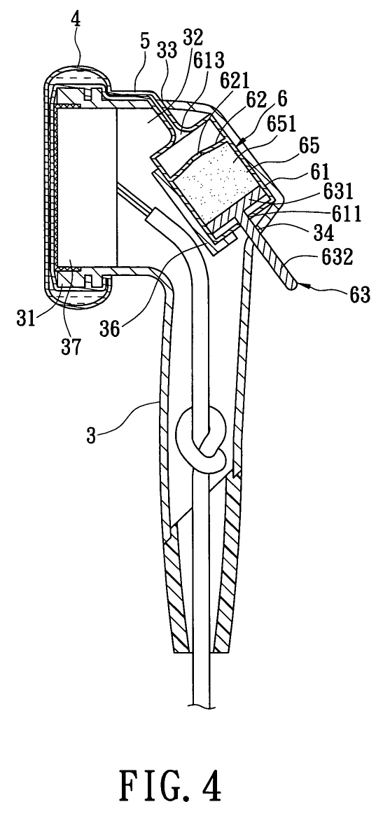

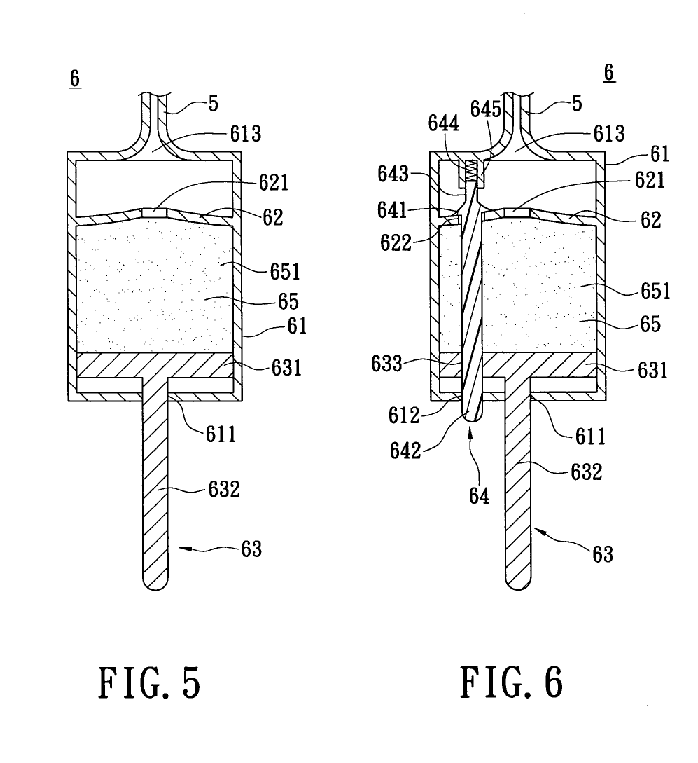

Referring to FIGS. 3 to 6, the present invention provides an ergonomic earphone, which comprises an earphone body 3, a silica cover 3, and a control mechanism 6 with a communicating portion 5.

The earphone body 3 includes a hollow side portion 31, a loudspeaker 37 received in the side portion 31, a remaining space 32 formed therein, a through hole 33 formed thereon, a first hole 34 and a second hole 35 formed thereon, and a positioning rib 36 formed in the remaining space 32.

The silica cover 4 covers the side portion 31 of the earphone body 3.

The control device 6 is used to expand and contract the silica cover 4. The control device 6 is received in the remaining space 32 and fixed by the positioning rib 36.

The control device 6 includes a housing 61, a separating plate 62, a first control device 63, a second control device 64, a channel 65 with material formed in the housing 61, a communicating portion 5 disposed through the through hole and communicating between an internal portion of the housing 61 and an internal portion of the silica cover 4.

The housing 61 includes an opening 613 communicated to the communicating portion 5, a first opening 611 and a second opening 612 communicated to the internal portion of the housing 61, and a separating plate 62 disposed therein and having a check valve 621 and a hole 622.

The first control device 63 includes a piston body 631 disposed in the housing 61 and a first control rod 632 connected to the piston body 631 for controlling the first control rod 632 to push the material to leave the channel through the check valve 621.

The second control device 64 includes a stop element 641 with one side for closing the hole 622 of the separating plate 62, a second control rod 642 with one side connected to the stop element 641 through the hole 622 of the separating plate 62, a rod body 643 with one side connected to another side of the stop element 641, and an elastic element 644 disposed between the rod body 643 and the housing 61. The second control device 64 is fixed in the housing 61 by the elastic element 644. The housing 61 further comprises a positioning cavity 645 formed therein for receiving the elastic element 644 and another side of the rod body 643. The other side of the rod body 643 is connected to the elastic element 644.

The other side of the first control rod 632 extends out of the first open 611 of the housing 61 and the first hole 34 of the earphone body 3. The other side of the second control rod 642 extends out of the second opening 612 of the housing 61 and the second hole 35 of the earphone body 3. Additionally, the second control rod 642 penetrates through the opening 633 of the piston body 631.

The user can push the first control rod 632 to transmit the material from the channel 65 to the silica cover 4 through the check valve 621 and the communicating portion 5 for expanding the silica cover 4 to adapt to the larger ear hole. Moreover, the user can push the second control rod 642 to open the hole 622 for guiding the material from the silica cover 4 go back to the channel 65 through the communicating portion 5 and the hole 622 for contracting the silica cover 4 to adapt to the smaller ear hole.

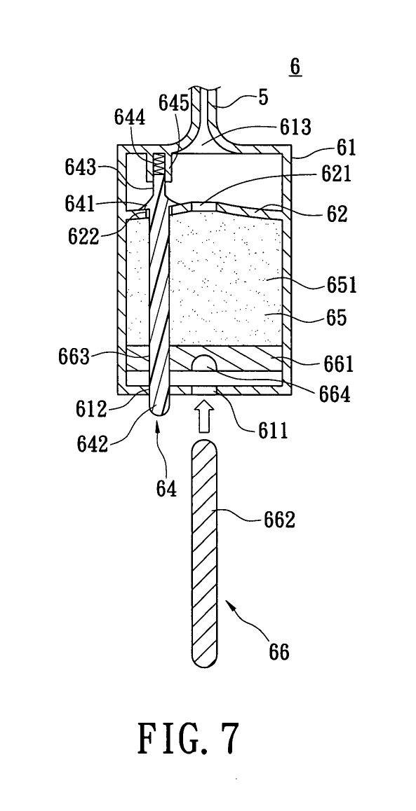

Furthermore, referring to the FIG. 7, another embodiment of the present invention includes a detachable control device 66. The detachable control device 66 has a piston body 661 and a detachable control rod 662. The piston body 661 has an opening 663 and a cavity 664. The detachable control rod 662 is detachably connected to the cavity 664 of the piston body 661 through the first hole 34 and first open 611.

Although the present invention has been described with reference to the preferred embodiment thereof, it will be understood that the invention is not limited to the details thereof. Various substitutions and modification have suggested in the foregoing description, and other will occur to those of ordinary skill in the art. Therefore, all such substitutions and modifications are intended to be embraced within the scope of the invention as defined in the appended claims.

1. An ergonomic earphone, comprising:
an earphone body having a side portion;
a silica cover covering the side portion of the earphone body; and
a control device communicating with an inside of the silica cover and disposed in the earphone body, the control device having a channel with a material formed therein, a first control device with a part received in the channel for controlling flow of the material into the inside of the silica cover from the channel, and a second control device with a part received in the channel for controlling returning of the material from the channel back to the inside of the silica cover.

2. The ergonomic earphone as claimed in claim 1, wherein the earphone body has a remaining space formed therein and the control device is received in the remaining space.

3. The ergonomic earphone as claimed in claim 2, wherein the earphone body comprises a through hole communicating with the remaining space, and the control device communicates with the inside of the silica cover through the through hole.

4. The ergonomic earphone as claimed in claim 2, wherein the earphone body comprises a first hole and a second hole, and the first and the second control device extend out of the first hole and the second hole, respectively.

5. The ergonomic earphone as claimed in claim 1, wherein the control device is a gas valve-type control device.

6. The ergonomic earphone as claimed in claim 5, wherein the control device comprises a housing and a separating plate disposed in the housing, the separating plate having a check valve and a hole respectively formed therein, the first control device being of a piston type and disposed in the housing, and the second control device disposed through the hole in the separated plate.

7. The ergonomic earphone as claimed in claim 6, wherein the first control device comprises a piston body disposed in the channel and a first control rod with one side connected to the piston body, and another side of the first control rod projecting out of the housing and the earphone body.

8. The ergonomic earphone as claimed in claim 6, wherein the first control device is a detachable control device, the detachable control device having a piston body disposed in the channel and a detachable control rod detachably connected to the piston body, the earphone body having a first hole, the housing having a first opening corresponding to the first hole of the earphone body, and the detachable control rod penetrating through the first hole and the first opening for pushing the piston.

9. The ergonomic earphone as claimed in claim 6, wherein the second control device comprises a stop element with one side for closing the hole of the separated plate, a second control rod with one side connected to the stop element and penetrating through the hole of the separated plate, and another side of the second control rod penetrating through the piston body of the first control device and projecting out of the earphone body and the housing.

10. The ergonomic earphone as claimed in claim 9, wherein the second control device comprises a rod body connected to another side of the stop element and an elastic element disposed between the rod body and the housing.
